(19) United States
(12) Patent Application Publication
(10) Pub. No.: US 2024/0208115 A1
(43) Pub. Date: Jun. 27, 2024

(54) STRUCTURAL COMPONENT, VEHICLE AND METHOD FOR PRODUCING A STRUCTURAL COMPONENT

(71) Applicant: ElringKlinger AG, Dettingen (DE)

(72) Inventors: Thomas WOLF, Göppingen (DE); Anna-Carin FÖHNER, Laichingen (DE); Pascale FELKE, Stuttgart (DE)

(73) Assignee: ElringKlinger AG, Dettingen (DE)

(21) Appl. No.: 18/598,787

(22) Filed: Mar. 7, 2024

Related U.S. Application Data
(63) Continuation of application No. PCT/EP2022/074025, filed on Aug. 30, 2022.

(30) Foreign Application Priority Data
Sep. 9, 2021 (DE) 10 2021 209 983.1

(51) Int. Cl. B29C 44/14; B29C 44/34; B29C 44/42; B29C 44/56; B29L 31/30

(52) U.S. Cl. CPC B29C 44/14; B29C 44/355; B29C 44/42; B29C 44/5627; B29K 2995/0097; B29L 2031/30

(57) ABSTRACT

In order to provide a structural component (100) for a vehicle (102), in particular a bulkhead (104) for a road vehicle, for example for a passenger car (106), which can be produced simply and cost-effectively and preferably simultaneously meets requirements relating to weight reduction and structural integrity, according to the invention the structural component (100), in particular the bulkhead (104), comprises the following: a main body (108), which comprises one or more foamed portions (124) and one or more compact portions (130), the structural component (100) preferably also comprising one or more cover elements (126) which cover the main body (108) in one or more foamed portions (124) and/or in one or more compact portions (130).

### RELATED APPLICATION

This application is a continuation of international application No. PCT/EP2022/074025 filed on Aug. 30, 2022, and claims the benefit of German application No. 10 2021 209 983.1 filed on Sep. 9, 2021, which are incorporated herein by reference in their entirety and for all purposes.

### FIELD OF DISCLOSURE AND BACKGROUND

The present invention relates to a structural component for a vehicle, in particular a bulkhead for a road vehicle, for example for a passenger car.

The present invention is based on the object of providing a structural component for a vehicle, in particular a bulkhead for a road vehicle, for example for a passenger car, which can be produced simply and cost-effectively and preferably simultaneously meets requirements relating to weight reduction and structural integrity.

### SUMMARY OF THE INVENTION

According to the invention, this object is achieved by a structural component for a vehicle, in particular a bulkhead for a road vehicle, for example for a passenger car, with the features of independent claim 1.

The structural component, in particular the bulkhead, preferably comprises the following: a main body, which comprises one or more foamed portions and one or more compact portions, wherein the structural component preferably also comprises one or more cover elements which cover the main body in one or more foamed portions and/or in one or more compact portions.

The term “in particular” is preferably used in the context of this description and the appended claims to describe optional features.

The structural component, in particular the bulkhead, is preferably designed to separate a passenger compartment of a vehicle, in particular an interior of a road vehicle, for example a passenger car, from a space arranged outside the passenger compartment, in particular outside the interior.

The structural component preferably comprises a first side and a second side facing away from the first side.

For example, it is conceivable that the first side of the structural component faces a passenger compartment of a vehicle, in particular an interior of a road vehicle, such as a passenger car, in an installed state.

In particular, the vehicle is a road vehicle. For example, the vehicle is a passenger car. Alternatively, it can be provided that the vehicle is a truck.

The structural component is preferably a flat component.

A maximum width and/or a maximum height of the structural component are preferably greater than a maximum thickness of the structural component by at least a factor of two, for example at least a factor of four.

A maximum width of the structural component is preferably greater than a maximum height of the structural component by at least a factor of two.

In particular, the structural component is a sandwich component.

It can be favorable if the structural component is designed to be load-path-compatible, wherein cover elements, in particular reinforcing elements, of the structural component are preferably arranged on portions with an increased load.

It can be favorable if a load-path-compatible configuration of the structural component is achieved by locally different material thicknesses and/or by a locally different degree of foaming and/or a locally different foaming rate.

Preferably, the structural component has a reduced material requirement and an increased lightweight construction potential, wherein production costs of the structural component can preferably be minimized.

The structural component is preferably designed to be substantially gas-tight.

Preferably, the structural component is produced using a tool.

In particular, no further steps are required to produce the structural component after the demolding of the structural component from a shaping tool.

The main body of the structural component is produced in particular in a so-called “one-shot” method, wherein preferably all portions of the main body are formed from the same plastic material.

The various portions of the main body preferably have a chemically identical composition and/or can be chemically characterized by the same structural formula and/or molecular formula.

The various portions of the main body can have different physical properties.

With one configuration of the structural component, it is provided that the main body of the structural component comprises or is formed from an injection-moldable plastic material.

The injection-moldable plastic material is a thermoplastic material, for example.

For example, it is conceivable that the injection-moldable plastic material is a fiber-reinforced plastic material.

The injection-moldable plastic material preferably comprises reinforcing fibers.

The reinforcing fibers are, for example, glass fibers and/or aramid fibers.

The reinforcing fibers of the fiber-reinforced plastic material are preferably short fibers and/or long fibers.

Within the framework of this description and the appended claims, short fibers are preferably understood to mean reinforcing fibers with a length of at most approximately 10 mm.

Within the framework of this description and the appended claims, long fibers are preferably understood to mean reinforcing fibers with a length in the range from at least approximately 10 mm to approximately 50 mm.

With one configuration of the structural component, the injection-moldable plastic material is a foamable plastic material.

The foamable plastic material is in particular a material that foams physically and/or chemically.

With physical foaming, for example, a compressed gas, such as carbon dioxide (CO2) or nitrogen (N2), is inserted into a screw of a shaping tool, in particular an injection tool.

With chemical foaming, for example, the injection-moldable plastic material contains a chemical blowing agent.

The injection-moldable plastic material, for example the foamable plastic material, preferably comprises a thermoplastic plastic material, preferably a polyolefin, for example polypropylene, and/or a polyamide.

It can be advantageous if the foamable plastic material is a material that foams up by reducing the pressure or by freeing up a space in a cavity of a shaping tool. Pressure reduction is achieved in particular by enlarging the cavity in the shaping tool.

With one configuration of the structural component, it is provided that the main body of the structural component comprises a foamed core region in a respective foamed portion, which is arranged on one or between two cover layers, in particular compact cover layers.

In the foamed core region of a foamed portion of the main body of the structural component, the injection-moldable plastic material of the main body, in particular the foamable plastic material, is preferably at least partially foamed.

In a compact cover layer of a foamed portion of the main body of the structural component, the injection-moldable plastic material of the main body, in particular the foamable plastic material, is preferably not foamed or only slightly foamed.

A respective compact cover layer of a foamed portion preferably forms a skin layer, which in particular completely covers the foamed core region of the foamed portion towards a surface of the main body.

A respective compact cover layer of a foamed portion is preferably produced by curing and/or cross-linking the injection-moldable plastic material, in particular the foamable plastic material, of the main body of the structural component prior to the foaming of the injection-moldable plastic material, in particular the foamable plastic material, i.e., prior to the production of the foamed core region of the foamed portion.

Preferably, after the injection of the injection-moldable plastic material, in particular the foamable plastic material, into a cavity of a shaping tool, a waiting or holding time is observed before the injection-moldable plastic material, in particular the foamable plastic material, is foamed and/or expanded.

A thickness of the compact cover layers of different foamed portions can preferably vary.

However, it can be favorable if the two compact cover layers of the same foamed portion in each case have approximately the same thickness.

Alternatively, it is conceivable that the two compact cover layers of the same foamed portion in each case have a different thickness.

Different thicknesses of the compact cover layers of the foamed portions of the main body of the structural component are produced, for example, by a different degree of cross-linking, i.e., different degrees of cross-linking from one another, or a different rate of curing of the injection-moldable plastic material, in particular the foamable plastic material, of the main body of the structural component prior to the foaming of the injection-moldable plastic material, in particular the foamable plastic material, i.e., prior to the production of the foamed core region of the foamed portion.

For example, a waiting or holding time after the injection of the injection-moldable plastic material, in particular the foamable plastic material, can be varied in different foamed portions, such that the compact cover layers of the different foamed portions in each case have a different thickness from one another.

Alternatively or additionally, different thicknesses of the compact cover layers of the foamed portions of the main body of the structural component are produced, for example, by tool parts of a shaping tool, for example tool halves and/or slide elements of a shaping tool, which can be controlled independently of one another in terms of time or location.

By varying the waiting or holding time, a thickness of the compact cover layers of the one or more foamed portions can preferably be influenced.

It can also be favorable if a setting of the thickness of the compact cover layers of the one or more foamed portions is effected by actively tempering a tool wall of a shaping tool that delimits a cavity.

In particular, it is conceivable that the thickness of the compact cover layers of the one or more foamed portions can be influenced by active tempering.

A degree of foaming and/or a foaming rate of the injection-moldable plastic material of the main body, in particular of the foamable plastic material, is preferably greater in the foamed core region of a foamed portion of the main body of the structural component than in a compact cover layer of the respective foamed portion by a factor of at least approximately 1.2, preferably of at least approximately 2, for example of at least approximately 5.

Within the framework of this description and the appended claims, a foaming rate is understood in particular to mean a degree of an increase in volume upon foaming of the injection-moldable plastic material of the main body, in particular of the foamable plastic material, after the injection of the same into a cavity of a shaping tool.

A degree of foaming and/or a foaming rate of the injection-moldable plastic material of the main body, in particular of the foamable plastic material, is preferably greater in the foamed core region of a foamed portion of the main body of the structural component than in a compact portion of the main body of the structural component by a factor of at least approximately 1.2, preferably of at least approximately 2, for example of at least approximately 5.

In a respective compact portion of the main body of the structural component, a gas content, relative to a total volume of the respective compact portion, is preferably at most approximately 10% by volume, for example at most approximately 5% by volume, preferably at most approximately 2% by volume.

A density of the main body in the foamed core region of a foamed portion is preferably smaller than in a compact cover layer of the respective foamed portion by a factor of at least approximately 1.2, preferably at least approximately 2, for example at least approximately 5.

In a foamed core region of a foamed portion of the main body of the structural component, a gas content, relative to a total volume of the respective foamed portion, is preferably at least approximately 10% by volume, for example at least approximately 20% by volume, preferably at least approximately 40% by volume.

It can also be favorable if a density of the main body in the foamed core region of a foamed portion is smaller than in a compact portion by a factor of at least approximately 1.2, preferably at least approximately 2, for example at least approximately 5.

With one configuration of the method, it is provided that
a) two compact cover layers of a foamed portion of the main body of the structural component have a distance relative to one another in the range from approximately 2 mm to approximately 50 mm, for example from approximately 3 mm to approximately 20 mm, preferably from approximately 3 mm to approximately 8 mm; and/or
b) a foamed core region of a foamed portion of the main body of the structural component has a height in the range from approximately 2 mm to approximately 50 mm, for example from approximately 3 mm to approximately 20 mm, preferably from approximately 3 mm to approximately 8 mm.

A distance between the two compact cover layers of a respective foamed portion of the main body of the structural component preferably corresponds to a height of a foamed core region of the respective foamed portion.

Preferably, the structural component can be designed to be particularly rigid by increasing the distance between the two compact cover layers of a foamed portion of the main body of the structural component and/or by increasing the height of a foamed core region of the foamed portion.

Preferably, noise and/or thermal insulation properties of the structural component can also be improved by increasing the distance between the two compact cover layers of a foamed portion of the main body of the structural component and/or by increasing the height of a foamed core region of the foamed portion.

With one configuration of the structural component, it is provided that a respective compact cover layer of a foamed portion of the main body of the structural component has a thickness of at least approximately 0.2 mm, for example of at least approximately 0.5 mm, preferably of at least approximately 1 mm.

Preferably, such a minimum thickness of the compact cover layers of the one or more foamed portions of the main body of the structural component can ensure that the main body of the structural component is designed to be substantially gas-tight in the region of a foamed portion of the main body.

Preferably, the main body is also designed to be gas-tight in a respective compact portion, such that the main body of the structural component can preferably be designed to be gas-tight as a whole.

With one configuration of the structural component, it is provided that the main body of the structural component comprises multiple foamed portions, wherein a foaming rate of the injection-moldable plastic material of the main body, in particular a foamable plastic material, is different in the foamed core regions of the multiple foamed portions.

Foamed core regions of different foamed portions of the main body of the structural component are foamed to different degrees.

Preferably, the main body of the structural component has a different density in the foamed core regions of the multiple foamed portions.

A density of the main body is preferably different in foamed core regions of different foamed portions.

For example, it is conceivable that a foamed core region of a first foamed portion of the main body of the structural component is more heavily foamed than a foamed core region of a second foamed portion of the main body of the structural component.

For example, it is conceivable that a different foaming rate and/or density in the foamed core regions of the multiple foamed portions is achieved by a temporally decoupled movement of slide elements of a shaping tool.

Alternatively or additionally, it is conceivable that the foaming of the injection-moldable plastic material of the main body, in particular the foamable plastic material, is effected in one stroke, wherein different slide elements can in particular have stroke distances that are different from one another.

For example, a stroke distance of a first slide element can be greater than a stroke distance of a second slide element.

With one configuration of the structural component, it is provided that one or more cover elements of the structural component are in each case reinforcing elements, which reinforce the main body of the structural component in one or more foamed portions and/or in one or more compact portions.

One or more cover elements, in particular one or more reinforcing elements, can for example comprise an organo sheet or can be designed as such.

An organo sheet preferably comprises a fiber material and a matrix material, in which the fiber material is embedded.

The matrix material is in particular a plastic material, for example a thermoplastic material.

It can be favorable if a cover element designed as an organo sheet, in particular a reinforcing element, is connected to the main body of the structural component in a firmly bonded manner.

It can be favorable if the matrix material of the organo sheet corresponds to the injection-moldable, in particular foamable, plastic material of the main body of the structural component.

A respective cover element, in particular a respective reinforcing element, of the structural component can, for example, have a material thickness in the range of approximately 0.2 mm to approximately 2 mm, for example a material thickness of approximately 0.5 mm.

Within the framework of this description and the appended claims, a “material thickness” of a cover element, in particular a reinforcing element, a core region of a foamed portion, a compact cover layer of a foamed portion and a compact portion is understood to mean in particular an average material thickness taken in a thickness direction.

With one configuration of the structural component, it is provided that one or more cover elements, in particular one or more reinforcing elements, of the structural component are connected to the main body in a firmly bonded manner, in particular by producing the main body in an injection molding process.

In particular, the main body of the structural component is injection-molded onto one or more cover elements, in particular one or more reinforcing elements, of the structural component.

Preferably, it is thus possible to dispense with process steps that are downstream of the injection molding process for producing the main body and that serve to connect the main body to one or more cover elements, in particular one or more reinforcing elements, in a firmly bonded manner.

With one configuration of the structural component, it is provided that the one or more cover elements, in particular one or more reinforcing elements, of the structural component comprise one or more of the following or are formed by one or more of the following:
a fiber composite material, which comprises, for example, a fiber fabric, a knitted fabric, a woven fabric, and/or a nonwoven fabric;
a fiber material, for example a fiber fabric, a knitted fabric, a woven fabric, and/or a nonwoven fabric;
a veneer material;
a foil material;
a metallic material, for example a metallic sheet, a metallic mesh, a metallic knit, and/or a metallic weave.

For example, it is conceivable that fibers of a fiber composite material are impregnated with the injection-moldable plastic material of the main body upon production of the main body, such that this preferably forms a matrix material in which the fiber composite material is embedded.

With one configuration of the structural component, it is provided that the structural component comprises one or more functional elements, in particular one or more sleeve elements, wherein the main body of the structural component is preferably injection-molded onto the one or more functional elements, in particular onto the one or more sleeve elements.

The structural component can preferably be functionalized by means of one or more functional elements, such that, for example, one or more connecting elements can be fixed to the structural component and/or that one or more connecting elements can be passed through a functional element, in particular through a sleeve element.

The structural component can preferably be fixed to a load-bearing structure of a vehicle, in particular a road vehicle, by means of one or more connecting elements, for example by means of one or more screw elements, which in each case can be passed through a sleeve element, for example.

A sleeve element of the structural component comprises or is formed from a metallic material, for example aluminum and/or steel.

In a direction running parallel to a longitudinal axis of the sleeve element, a respective sleeve element of the structural component preferably has a height that is equal to or less than a material thickness of the structural component in a region that directly surrounds the sleeve element.

With one configuration of the structural component, it is provided that the injection-moldable plastic material, in particular the foamable plastic material, of the main body of the structural component is designed to be compact in a region that directly surrounds a functional element, in particular a sleeve element.

Furthermore, with one configuration of the structural component, it can preferably be provided that one or more connection regions and/or fastening regions are provided, by means of which the structural component can be fixed to one or more other components and/or to which one or more other components can be fixed to the structural component.

One or more connection regions and/or fastening regions are preferably formed by pressing the main body and/or by omitting a core region of the main body in a partial region thereof, for example in the partial region into which forces can be introduced to realize the connection and/or fastening, in order to then transfer them to other regions or parts of the main body.

Alternatively or additionally, one or more insert elements can be provided for insertion between two cover layers of the main body, in particular for insertion into a part of the main body to be pressed in and/or into a part of the main body in which no core region is provided. As a result, a stable connection and/or fastening region can preferably be provided.

The one or more connection regions and/or fastening regions can preferably be produced and/or finished by injection-molding plastic material onto a pressed-in part of the main body and/or onto a part of the main body with an omitted core region.

Functional elements, in particular sleeve elements, of the structural component are preferably arranged in a compact portion of the main body of the structural component.

A compact portion of the main body of the structural component preferably forms a circumferential edge portion of the main body of the structural component.

For example, it is conceivable that functional elements, in particular sleeve elements, of the structural component are arranged in an edge portion of the main body of the structural component, which is preferably closed in a ring shape and designed as a compact portion.

The injection-moldable plastic material, in particular the foamable plastic material, of the main body of the structural component is preferably not or only slightly foamed in the region that directly surrounds a functional element, in particular a sleeve element.

Preferably, functional elements, in particular sleeve elements, can thus also be arranged in a foamed portion of the main body of the structural component.

With one configuration of the structural component, it is provided that the structural component comprises one or more of the following:
a mounting portion, which is defined for fixing one or more pedals, for example a brake pedal, of a vehicle, in particular a road vehicle, for example a passenger car;
a passage portion through which a steering column of a vehicle, in particular a road vehicle, for example a passenger car, can be passed.

The structural component is preferably designed to dissipate forces acting on a vehicle brake pedal upon braking.

Preferably, deformation of the structural component due to the forces acting on a vehicle brake pedal upon braking is minimal.

With one configuration of the structural component, it is provided that the structural component comprises a sealing element, which is injection-molded onto the main body of the structural component.

The main body of the structural component preferably remains integrally molded and/or is not yet demolded from a shaping tool in order to inject the sealing element.

In particular, the sealing element is injection-molded onto the main body of the structural component in a two-component injection molding process.

The sealing element preferably comprises a plastic material, for example an elastomer material.

The plastic material of the sealing element is, for example, a thermoplastic elastomer material (TPE).

Alternatively, it is conceivable that the sealing element comprises or is formed from polyurethane and is applied to the already demolded main body, for example by means of a foam dispenser device, which is robot-guided, for example.

With one configuration of the structural component, it is provided that the main body of the structural component comprises one or more stiffening elements, for example stiffening ribs, wherein injection-moldable and/or foamable plastic material of the main body of the structural component is preferably compact and/or not foamed in the one or more stiffening elements, in particular the stiffening ribs, of the main body of the structural component.

A degree of foaming and/or a foaming rate of the injection-moldable plastic material of the main body, in particular of the foamable plastic material, corresponds in a stiffening element, for example in a stiffening rib, preferably substantially to a degree of foaming and/or a foaming rate in a compact portion of the main body.

Stiffening elements, for example stiffening ribs, preferably adjoin a compact portion of the main body and in particular have a substantially identical degree of foaming and/or a substantially identical foaming rate as this compact portion of the main body adjoining the stiffening elements.

With one configuration of the structural component, it is provided that the main body of the structural component comprises a foamed and post-compressed portion, wherein the foamed and post-compressed portion preferably comprises a foamed core region that is arranged on or between two cover layers, in particular compact cover layers, wherein the foamed core region preferably comprises a post-compressed region.

A compact cover layer of a foamed and post-compressed portion is preferably designed substantially identical to a compact cover layer of a foamed portion.

In particular, a compact cover layer of a foamed and post-compressed portion has substantially the same material properties as a compact cover layer of a foamed portion.

In the post-compressed region of the foamed core region of a foamed and post-compressed portion, the main body of the structural component preferably has a density that is greater than a density of the main body in the foamed core region of the foamed and post-compressed portion outside the post-compressed region.

A density of the main body in the post-compressed region can, for example, substantially correspond to a density of the main body in a compact cover layer of the foamed and post-compressed portion.

With one configuration of the structural component, it is provided that the structural component comprises the following:
a first foamed portion;
a second foamed portion;
a compact portion; and
two reinforcing elements,
   wherein the two reinforcing elements cover, in particular completely, a surface of the main body of the structural component in the first foamed portion,
   wherein the main body of the structural component in the first foamed portion has a density that is smaller than a density of the main body in the second foamed portion, and
   wherein the compact portion forms a circumferential edge portion of the main body of the structural component, which surrounds the first foamed portion and the second foamed portion.

It can be favorable if the compact cover layers of the first foamed portion have a smaller thickness than the compact cover layers of the second foamed portion.

The present invention also relates to a vehicle, in particular a road vehicle, for example a passenger car or truck, wherein the vehicle comprises a structural component according to the invention.

The present invention also relates to a method for producing a structural component for a vehicle, in particular a method for producing a bulkhead for a road vehicle.

The present invention is based on the further object of providing a method for producing a structural component for a vehicle, in particular a method for producing a splash wall for a road vehicle, for example for a passenger car, by means of which the structural component, in particular the splash wall, can be produced simply and cost-effectively, wherein the structural component, in particular the splash wall, preferably simultaneously meets requirements relating to weight reduction and structural integrity.

According to the invention, this object is achieved by a method for producing a structural component for a vehicle with the features of claim 19.

The method according to the invention for producing a structural component for a vehicle, in particular for producing a bulkhead for a road vehicle, for example for a passenger car, is preferably suitable for producing a structural component according to the invention for a vehicle, in particular a bulkhead for a road vehicle, for example for a passenger car.

Preferably, the method comprises the following steps:
Providing a cover element, in particular a reinforcing element;
Inserting one or more cover elements, in particular one or more reinforcing elements, into a cavity of a shaping tool;
Injecting a foamable plastic material into the cavity of the shaping tool;
Foaming the foamable plastic material.

The method according to the invention for producing a structural component for a vehicle, in particular for producing a bulkhead for a road vehicle, for example for a passenger car, preferably has individual or multiple of the features and/or advantages described in connection with the structural component according to the invention for a vehicle, in particular the bulkhead for a road vehicle, for example for a passenger car.

Furthermore, the structural component for a vehicle according to the invention, in particular the bulkhead for a road vehicle, for example for a passenger car, preferably has individual or multiple of the features and/or advantages described in connection with the method according to the invention for producing a structural component for a vehicle, in particular for producing a bulkhead for a road vehicle, for example for a passenger car.

The foamable plastic material is preferably only foamed in portions.

Preferably, the method steps listed above are carried out in the specified order.

After the foaming of the foamable plastic material, it preferably hardens, such that the foamable plastic material forms a main body of the structural component.

It can be favorable if the one or more cover elements are heated prior to the injection of the foamable plastic material into the cavity of the shaping tool, in particular prior to the insertion of the one or more cover elements into the cavity of the shaping tool.

The shaping tool is in particular a plunging edge tool and/or slide tool.

Preferably, the foamable plastic material is foamed to different degrees in portions.

With one configuration of the method for producing a structural component, it is provided that a waiting or holding time is observed prior to the foaming of the foamable plastic material.

With one configuration of the method for producing a structural component, it is provided that individual slide elements of a shaping tool for foaming the foamable plastic material are moved over stroke distances that are different from one another.

With one configuration of the method for producing a structural component, it is provided that the foamable plastic material is post-compressed at least in portions after the foaming of the same.

Further preferred features and/or advantages of the invention form the subject-matter of the following description and the drawings illustrating embodiments.

### BRIEF DESCRIPTION OF THE DRAWINGS

FIG. 1 shows a schematic perspective representation of a first side of an embodiment of a structural component for a vehicle;

FIG. 2 shows a schematic top view of the first side of the embodiment of a structural component for a vehicle shown in FIG. 1;

FIG. 3 shows a schematic perspective representation of a second side of the embodiment of a structural component for a vehicle from FIG. 1;

FIG. 4 shows a schematic perspective representation of a sealing element of the embodiment of a structural component for a vehicle from FIG. 1;

FIG. 5 shows a schematic top view of a first side of a further embodiment of a structural component;

FIG. 6 shows a schematic sectional view through a structural component for a vehicle according to the embodiments of a structural component shown in FIGS. 1 and 5 in a compact portion of a main body of the structural component;

FIG. 7 shows a schematic sectional view of a structural component for a vehicle according to the embodiments of a structural component shown in FIGS. 1 and 5 in a foamed portion of a main body of the structural component;

FIG. 8 shows a schematic sectional view through a structural component for a vehicle according to the embodiments of a structural component shown in FIGS. 1 and 5 in a foamed portion of a main body of the structural component, wherein the main body in the foamed portion is covered on both sides with a cover element;

FIG. 9 shows a schematic sectional view of a structural component for a vehicle according to the embodiments of a structural component shown in FIGS. 1 and 5 in a foamed portion of a main body of the structural component, wherein the main body in the foamed portion is covered on one side with a cover element;

FIG. 10 shows a schematic sectional view of the embodiment of a structural component for a vehicle shown in FIG. 5 in a compact portion of a main body of the structural component, wherein the main body in the compact portion is covered on both sides with a cover element;

FIG. 11 shows a schematic sectional view through the embodiment of a structural component for a vehicle shown in FIG. 5 in a compact portion of a main body of the structural component, wherein the main body in the compact portion is covered on one side with a cover element;

FIG. 12 shows a schematic sectional view of a further embodiment of a structural component for a vehicle in a foamed and post-compressed portion of a main body of the structural component, wherein the main body in the foamed and post-compressed portion is covered on both sides with a cover element; and

FIG. 13 shows a schematic sectional view of a further embodiment of a structural component for a vehicle in a foamed and post-compressed portion of a main body of the structural component.

The same or functionally equivalent elements are provided with the same reference signs in all figures.

### DETAILED DESCRIPTION OF THE DRAWINGS

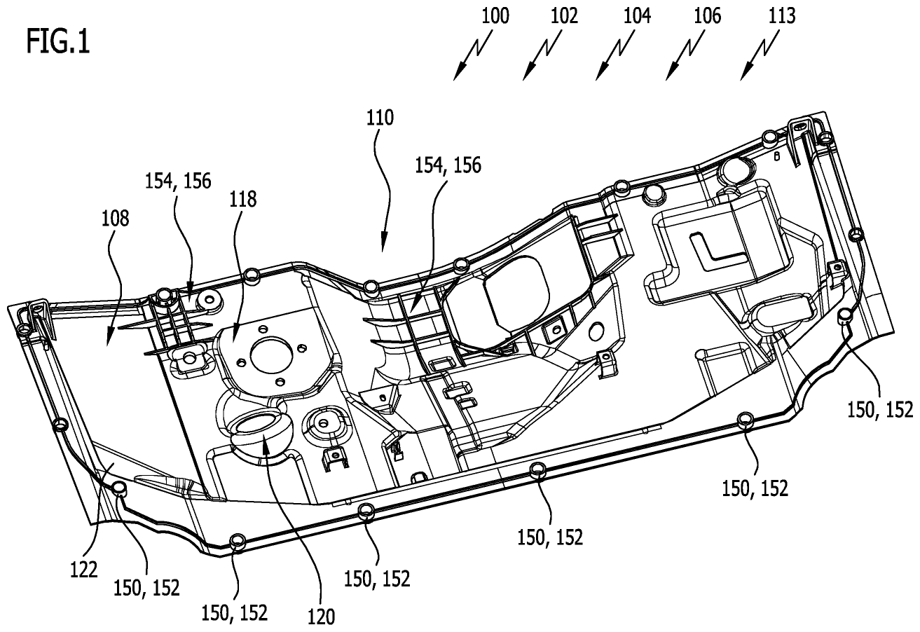

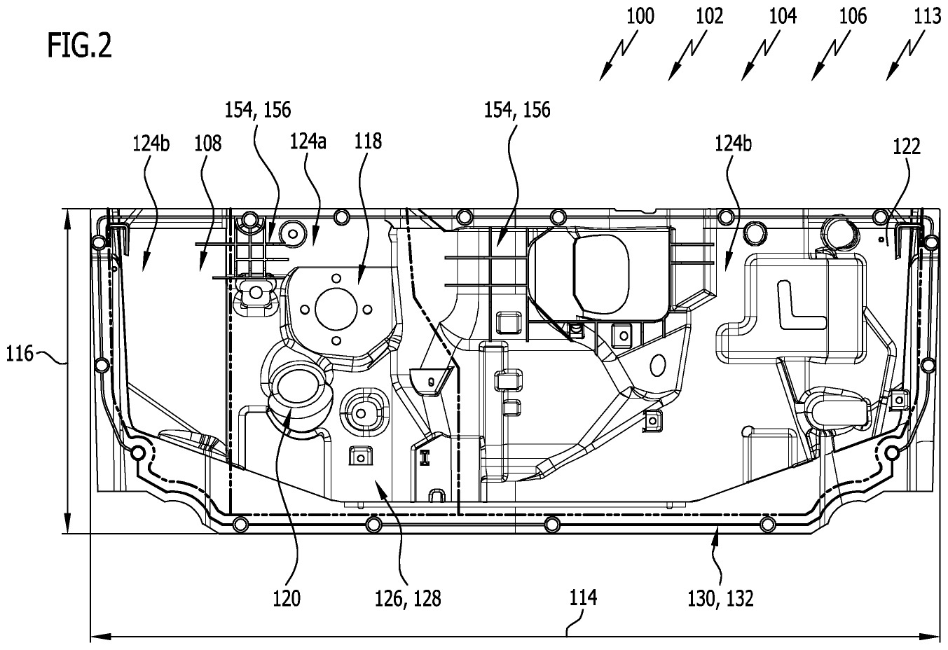

An embodiment, shown schematically in FIGS. 1 to 4 and designated 100 as a whole, of a structural component for a vehicle 102, in particular a bulkhead 104 for a passenger car 106, preferably comprises a main body 108.

The structural component 100, in particular the bulkhead 104, is preferably designed to separate a passenger compartment of a vehicle 102 not shown in the drawings, in particular an interior of a passenger car 106 not shown in the drawings, from a space arranged outside the passenger compartment, in particular outside the interior.

The structural component 100 preferably comprises a first side 110 and a second side 112 facing away from the first side 110.

For example, it is conceivable that the first side 110 of the structural component 100 faces a passenger compartment of a vehicle 102, in particular an interior of a passenger car, in an installed state of the structural component 100.

The structural component 100 is preferably designed to be substantially gas-tight.

It can be favorable if the structural component 100 is a flat component.

In particular, the structural component 100 is a sandwich component 113.

A maximum width 114 and/or a maximum height 116 of the structural component are preferably greater than a maximum thickness of the structural component 100 by a factor of at least two, for example by a factor of at least four.

The maximum width 114 of the structural component 100 is preferably greater than the maximum height 116 of the structural component 100 by at least a factor of two.

The structural component 100 preferably comprises a mounting portion 118, which is defined for fixing one or more pedals, for example a brake pedal, of a vehicle 102, in particular a passenger car 106, not shown in the drawings.

It can be favorable if the structural component 100 also comprises a passage portion 120, through which a steering column of a vehicle, in particular of a passenger car, not shown in the drawings, can be passed.

The structural component 100 is preferably designed to dissipate forces acting on a brake pedal of a vehicle 102, in particular a passenger car 106, upon braking.

Preferably, a deformation of the structural component 100 due to the forces acting on a brake pedal of a vehicle 102, in particular a passenger car 106, upon braking is minimal.

The main body 108 of the structural component 100 preferably comprises or is formed from an injection-moldable plastic material 122.

The main body 108 of the structural component 100 is preferably an injection-molded component.

The injection-moldable plastic material 122 of the main body 108 of the structural component 100 is, for example, a thermoplastic plastic material. For example, it is conceivable that the injection-moldable plastic material 122 is a fiber-reinforced plastic material.

In particular, the injection-moldable plastic material 122 comprises reinforcing fibers.

The reinforcing fibers are, for example, glass fibers and/or aramid fibers.

The reinforcing fibers of the fiber-reinforced plastic material are preferably short fibers and/or long fibers.

The injection-moldable plastic material 122 of the main body 108 of the structural component 100 is preferably a foamable plastic material. The foamable plastic material is in particular a material that foams physically and/or chemically.

With physical foaming, for example, a compressed gas, such as carbon dioxide (CO2) or nitrogen (N2), is inserted into a screw of a shaping tool, in particular an injection tool.

With chemical foaming, the injection-moldable plastic material 122 of the main body 108 of the structural component 100 comprises, for example, a chemical blowing agent by means of which the injection-moldable plastic material 122 is preferably foamable.

The injection-moldable plastic material 122 of the main body 108 of the structural component 100, for example the foamable material, preferably comprises a thermoplastic plastic material, preferably a polyolefin, for example polypropylene, and/or a polyamide.

It can be advantageous if the foamable material is a material that foams up by reducing the pressure or by freeing up a space in a cavity of a shaping tool. The pressure reduction is generated in particular by enlarging the cavity in the shaping tool.

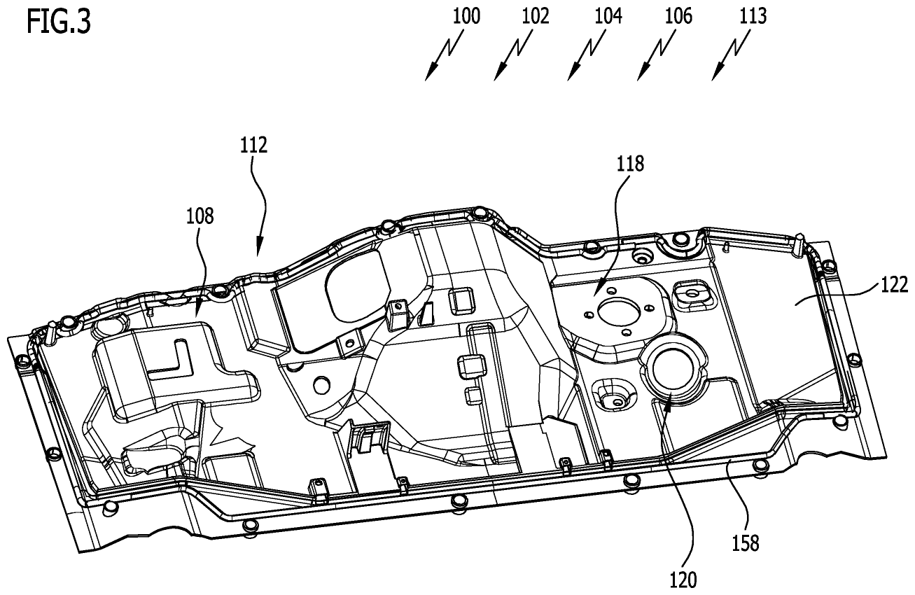

The main body 108 of the structural component 100 preferably comprises two foamed portions 124, in particular a first foamed portion 124a and a second foamed portion 124b (see FIG. 3).

The main body 108 of the embodiment of a structural component 100 shown in FIGS. 1 to 4 preferably further comprises a cover element 126, in particular one or more, for example two, reinforcing elements 128.

The cover elements 126, in particular the reinforcing elements 128, are only shown schematically in FIG. 3 by means of an arrow.

The two reinforcing elements 128 preferably cover a surface of the main body 108 of the structural component 100 in the first foamed portion 124a, in particular completely.

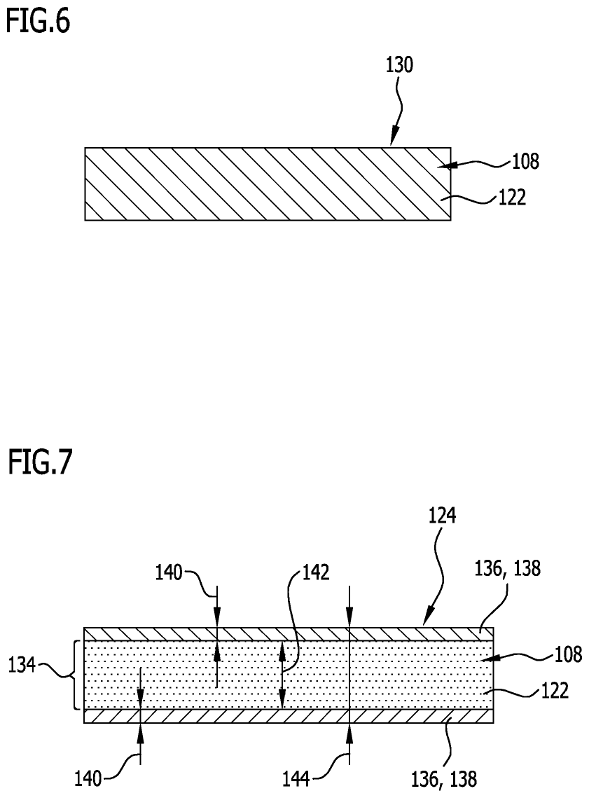

It can be favorable if the main body 108 of the structural component 100 comprises a compact portion 130, which is shown in FIG. 6 in a sectional view.

The compact portion 130 of the main body 108 of the structural component 100 preferably forms a circumferential and/or an edge portion 132 closed in a ring shape of the main body 108 of the structural component 100, which surrounds the first foamed portion 124a and the second foamed portion 124b in a circumferential direction.

The various portions 124, 130 of the main body 108 of the structural component preferably have a chemically identical composition and/or can be chemically characterized by the same structural formula and/or empirical formula.

However, the various portions 124, 130 of the main body 108 of the structural component 100 can have physically different properties.

The main body 108 of the structural component 100 in each case preferably comprises a foamed core region 134 in each of the two foamed portions 124, which is arranged between two particularly compact cover layers 136.

The foamed portions 124, which comprise a foamed core region 134 arranged between two compact cover layers 136, are shown, for example, in FIGS. 7 and 8.

In the foamed core region 134 of the foamed portions 124 of the main body 108 of the structural component 100, the injection-moldable plastic material 122 of the main body, in particular the foamable plastic material, is preferably at least partially foamed.

In a compact cover layer 136 of the foamed portions 124 of the main body 108 of the structural component 100, the injection-moldable plastic material 122 of the main body 108, in particular the foamable plastic material, is preferably not foamed or only slightly foamed.

The compact cover layers 136 of the foamed portions 124 preferably in each case form a skin layer 138, which in particular completely covers the foamed core region 134 of the respective foamed portion 124 towards a surface of the main body 108.

The compact cover layers 136 of the foamed portions 124 are preferably formed by curing and/or cross-linking the injection-moldable plastic material 122, in particular the foamable plastic material, of the main body 108 of the structural component 100 prior to the foaming of the injection-moldable plastic material, in particular the foamable plastic material, i.e., prior to the production of the foamed core region 134 of the foamed portions 124.

Preferably, after the injection of the injection-moldable plastic material 122, in particular the foamable plastic material, into a cavity of a shaping tool not shown in the drawings, a waiting or holding time is observed before the injection-moldable plastic material 122, in particular the foamable plastic material, is foamed and/or expanded.

Preferably, a degree and/or a foaming rate of the injection-moldable plastic material 122 of the main body 108, in particular the foamable plastic material, is greater in the foamed core region 134 of the foamed portions 124 of the main body 108 of the structural component 100 than in the compact cover layers 136 of the foamed portions 124 by a factor of at least approximately 1.2, preferably at least approximately 2, for example at least approximately 5.

A degree of foaming and/or a foaming rate of the injection-moldable plastic material 122 of the main body 108, in particular the foamable plastic material, is preferably greater in the foamed core region 134 of the foamed portions 124 of the main body 108 of the structural component 100 than in the compact portion 130 of the main body 108 of the structural component 100 by a factor of at least approximately 1.2, preferably at least approximately 2, for example at least approximately 5.

A density of the main body 108 of the structural component 100 is preferably greater in the foamed core regions of the foamed portions 124 than in the compact cover layers 136 of the foamed portions 124 by a factor of at least approximately 1.2, preferably at least approximately 2, for example at least approximately 5.

A density of the main body 108 of the structural component 100 is preferably greater in the foamed core regions 134 of the foamed portions 124 than in the compact portion 130 by a factor of at least approximately 1.2, preferably at least approximately 2, for example at least approximately 5.

In the compact portion 130 of the main body 108 of the structural component 100, a gas content, relative to a total volume of the compact portion 130, is preferably at most approximately 10% by volume, for example at most approximately 5% by volume, preferably at most approximately 2% by volume.

In the foamed core regions 134 of the foamed portions 124 of the main body 108 of the structural component 100, a gas content, relative to a total volume of the respective foamed portion 124, is preferably at least approximately 10% by volume, for example at least approximately 20% by volume, preferably at least approximately 40% by volume.

The two compact cover layers 136 of the same foamed portion 124 preferably in each case have approximately the same thickness 140.

A thickness 140 of the compact cover layers 136 of different foamed portions 124 can vary.

For example, a thickness 140 of the compact cover layers 136 in the first foamed portion 124a can be preferably smaller than a thickness 140 of the compact cover layers 136 in the second foamed portion 124b due to the cover elements 126, in particular the reinforcing elements 128, which preferably cover a surface of the main body 108 of the structural component 100 in the first foamed portion 124a.

The compact cover layers 136 of the foamed portions 124 of the main body 108 of the structural component 100 preferably have a thickness 140 of at least approximately 0.2 mm, for example at least approximately 0.5 mm, preferably at least approximately 1 mm.

Preferably, such a minimum thickness of the compact cover layers 136 of the foamed portions 124 of the main body 108 of the structural component 100 can ensure that the main body 108 of the structural component 100 is designed to be substantially gas-tight in the region of a foamed portion 124 of the main body 108.

The main body 108 of the structural component 100 is preferably also designed to be gas-tight in the compact portion 130, such that the main body 108 of the structural component 100 can preferably be designed to be gas-tight as a whole.

It can be favorable if the two compact cover layers 136 of a respective foamed portion 124 of the main body 108 of the structural component 100 have a distance 142 relative to one another in the range from approximately 2 mm to approximately 50 mm, for example from approximately 3 mm to approximately 20 mm, preferably from approximately 3 mm to approximately 8 mm.

It can also be favorable if a foamed core region 134 of a respective foamed portion 124 of the main body 108 of the structural component 100 has a height 144 in the range from approximately 2 mm to approximately 50 mm, for example from approximately 3 mm to approximately 20 mm, preferably from approximately 3 mm to approximately 8 mm.

The distance 142 between the two compact cover layers 136 of a respective foamed portion 124 of the main body 108 of the structural component 100 preferably corresponds to the height 144 of the foamed core region 134 of the respective foamed portion 124.

Preferably, the structural component 100 can be designed to be particularly rigid by increasing the distance 142 between the two compact cover layers 136 of the foamed portions 124 of the main body 108 of the structural component 100 and/or by increasing the height 144 of the foamed core region 134 of the foamed portions 124.

Preferably, noise and/or thermal insulation properties of the structural component 100 can also be improved by increasing the distance 142 between the two compact cover layers 136 of the foamed portions 124 of the main body 108 of the structural component 100 and/or by increasing the height 144 of the foamed core region 134 of the foamed portions 124.

It can be favorable if a foaming rate of the injection-moldable plastic material 122 of the main body 108 of the structural component 100, in particular of the foamable plastic material, is different in the foamed core regions 134 of the first foamed portion 124a and the second foamed portion 124b.

The foamed core regions 134 of the first foamed portion 124a and the second foamed portion 124b are preferably foamed to different degrees.

In particular, the main body 108 of the structural component 100 has a different density in the foamed core regions 134 of the first foamed portion 124a and the second foamed portion 124b.

For example, it is conceivable that the foamed core region 134 of the first foamed portion 124a of the main body 108 of the structural component 100 is more heavily foamed than the foamed core region 134 of the second foamed portion 124b of the main body 108 of the structural component 100.

In particular, it is conceivable that a different foaming rate and/or density in the foamed core regions 134 of the foamed portions is achieved by a temporally decoupled movement of slide elements of a shaping tool not shown in the drawings.

Alternatively or additionally, it is conceivable that the foaming of the injection-moldable plastic material 122 of the main body 108 of the structural component 100, in particular of the foamable plastic material, is effected in one stroke, wherein different slide elements can in particular have stroke distances that are different from one another.

For example, a stroke distance of a first slide element can be greater than a stroke distance of a second slide element.

Preferably, the reinforcing elements 128 reinforce the main body 108 of the structural component 100.

The cover elements 126, in particular the reinforcing elements 128, can for example comprise an organo sheet 146 or be formed as such.

An organo sheet 146 preferably comprises a fiber material and a matrix material, in which the fiber material is embedded.

The matrix material is in particular a plastic material, for example a thermoplastic material.

It can be favorable if a cover element 126, in particular a reinforcing element 128, formed as an organo sheet 146 is connected to the main body 108 of the structural component 100 in a firmly bonded manner.

It can be favorable if the matrix material of the organo sheet 146 corresponds to the injection-moldable, in particular foamable, plastic material 122 of the main body 108 of the structural component 100.

The cover elements 126, in particular the reinforcing elements 128, are connected to the main body 108 in a firmly bonded manner, in particular by producing the main body 108 in an injection molding process.

The main body 108 of the structural component 100 is preferably injection-molded onto the cover elements 126, in particular to the reinforcing elements 128, of the structural component 100.

Preferably, it is thus possible to dispense with process steps that are downstream of the injection molding process for producing the main body 108 and that serve to connect the main body 108 to the cover elements 126, in particular the reinforcing elements 128, in a firmly bonded manner.

A respective cover element 126, in particular a respective reinforcing element 128, of the structural component 100 can, for example, have a material thickness 148 in the range of approximately 0.2 mm to approximately 2 mm, for example a material thickness 148 of approximately 0.5 mm.

The cover elements 126, in particular the reinforcing elements 128, of the structural component 100 preferably comprise a fiber composite material, which for example comprises a fiber fabric, a knitted fabric, a woven fabric, and/or a nonwoven fabric.

It can be favorable if fibers of the fiber composite material are impregnated with the injection-moldable plastic material of the main body 108 upon production of the main body 108, such that this preferably forms a matrix material in which the fiber composite material is embedded.

In order to be able to fix the structural component 100 to a load-bearing structure of a vehicle 102, in particular a passenger car 106, it can be provided that the structural component comprises multiple functional elements 150, in particular multiple sleeve elements 152 (see FIG. 1).

For reasons of clarity, only individual functional elements 150 or sleeve elements 152 are marked with a reference sign in FIG. 1.

The main body 108 of the structural component 100 is preferably injection-molded onto the functional elements 150, in particular to the sleeve elements 152.

The structural component 100 can preferably be functionalized by means of the functional elements 150, such that, for example, connecting elements not shown in the drawings can be fixed to the structural component 100 and/or that connecting elements not shown in the drawings can be passed through a functional element 150, in particular through a sleeve element 150.

For example, the sleeve elements 152 of the structural component 100 comprise or are formed from a metallic material, such as aluminum.

In a direction running parallel to a longitudinal axis of the sleeve element 152, a respective sleeve element 152 of the structural component 100 preferably has a height that is equal to or less than a material thickness of the structural component 100 in a region that which directly surrounds the sleeve element 152.

It can be favorable if the injection-moldable plastic material 122, in particular the foamable plastic material, of the main body 108 of the structural component 100 is compactly formed in a region that directly surrounds a respective functional element 150, in particular a respective sleeve element 152.

Preferably, the functional elements 150, in particular the sleeve elements 152, of the structural component 100 are arranged in the compact portion 130 of the main body 108 of the structural component 100, in particular in the edge portion 132.

Due to the fact that the injection-moldable plastic material 122, in particular the foamable plastic material, of the main body 108 of the structural component 100 is preferably not or only slightly foamed in the region directly surrounding a functional element 150, in particular a sleeve element 152, functional elements 150, in particular sleeve elements 152, can preferably also be arranged in a foamed portion 124 of the main body 108 of the structural component 100.

It can be favorable if the main body 108 of the structural component 100 comprises multiple stiffening elements 154, for example stiffening ribs 156, wherein the injection-moldable plastic material 122 of the main body 108 of the structural component 100 is preferably compact and/or not foamed in the stiffening elements 154, in particular the stiffening ribs 156, of the main body 108 of the structural component 100.

A degree of foaming and/or a foaming rate of the injection-moldable plastic material 122 of the main body 108, in particular of the foamable plastic material, preferably substantially corresponds in the stiffening elements 154, in particular in the stiffening ribs 156, to a degree of foaming and/or a foaming rate in the compact portion 130 of the main body 108 of the structural component 100.

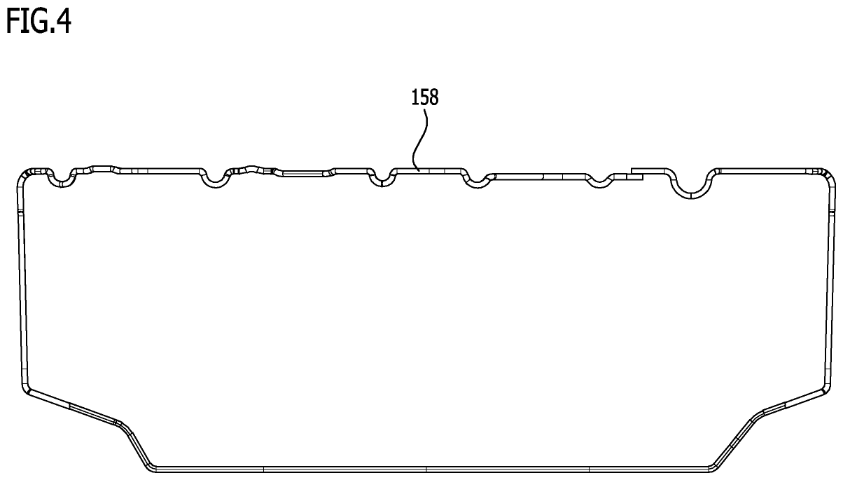

FIG. 4 shows a sealing element 158 of the structural component 100, which is injection-molded onto the main body 108 of the structural component 100 (see for example FIG. 3).

The main body 108 of the structural component 100 preferably remains integrally molded and/or is not yet demolded from a shaping tool in order to inject the sealing element 158.

In particular, the sealing element 158 is injection-molded onto the main body 108 of the structural component 100 in a two-component injection molding process.

The sealing element 158 preferably comprises a plastic material, for example an elastomer material.

The plastic material of the sealing element 158 is, for example, a thermoplastic elastomer material (TPE).

The structural component 100 is preferably produced using a tool.

In particular, no further steps are required to produce the structural component 100 after the demolding of the structural component 100 from a shaping tool.

The main body 108 of the structural component 100 is produced in particular in a so-called “one-shot” method, wherein preferably all portions of the main body 108 are formed from the same plastic material.

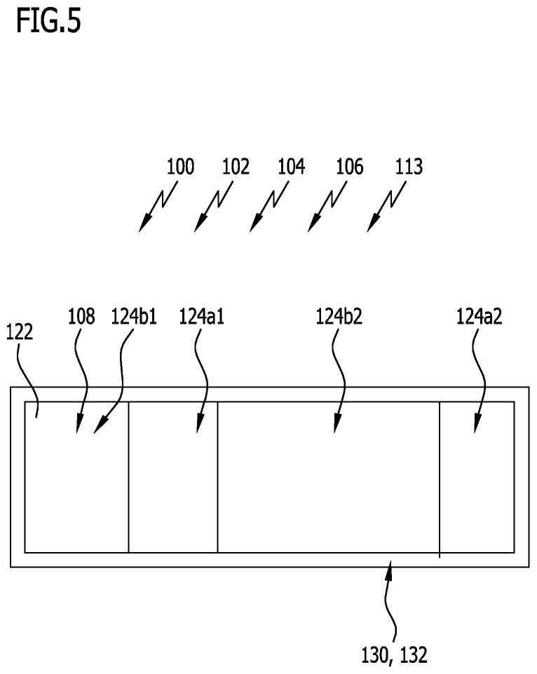

An embodiment of a structural component 100 for a vehicle 102, in particular a bulkhead 104 for a passenger car 106, shown in FIG. 5, differs from the embodiment of a structural component 100 for a vehicle 102, in particular a bulkhead 104 for a passenger car 106, shown in FIGS. 1 to 4, substantially in that cover elements 126, in particular reinforcing elements 128, cover the main body 108 of the structural component in some portions on one side only.

The foamed portion 124b1 shown in FIG. 5 substantially corresponds to the second foamed portion 124b of the main body 108 of the embodiment of a structural component 100 shown in FIGS. 1 to 4.

The foamed portion 124a1 shown in FIG. 5 substantially corresponds to the first foamed portion 124a of the main body 108 of the embodiment of a structural component 100 shown in FIGS. 1 to 4.

In the foamed portion 124b2, the compact cover layers 136 preferably have a thickness 140 that is different from a thickness of the compact cover layers 136 in the foamed portion 124b1.

Different thicknesses 140 of the compact cover layers 136 of the foamed portions 124 of the main body 108 of the structural component 100 are produced, for example, by a different degree of cross-linking, i.e., degrees of cross-linking that are different from one another, or a different rate of curing of the injection-moldable plastic material 122, in particular the foamable plastic material, of the main body 108 of the structural component 100 prior to the foaming of the injection-moldable plastic material 122, in particular the foamable plastic material, i.e., prior to the production of the foamed core regions 134 of the foamed portions 124.

For example, a waiting or holding time after the injection of the injection-moldable plastic material 122, in particular the foamable plastic material, can be varied in different foamed portions 124, such that the compact cover layers 136 of the different foamed portions 124 in each case have a different thickness 140 from one another.

Alternatively or additionally, different thicknesses 140 of the compact cover layers 136 of the foamed portions 124 of the main body 108 of the structural component 100 are produced, for example, by tool parts of a shaping tool, for example tool halves and/or slide elements of a shaping tool, which can be controlled independently of one another in terms of time or location.

By varying the waiting or holding time, the thickness 140 of the compact cover layers 136 of the foamed portions 124 can preferably be influenced.

It can also be favorable if a setting of a thickness 140 of the compact cover layers 136 of the foamed portions 124 is effected by actively tempering a tool wall of a shaping tool that delimits a cavity.

In particular, it is conceivable that a thickness 140 of the compact cover layers 136 of the foamed portions 124 can be influenced by active tempering.

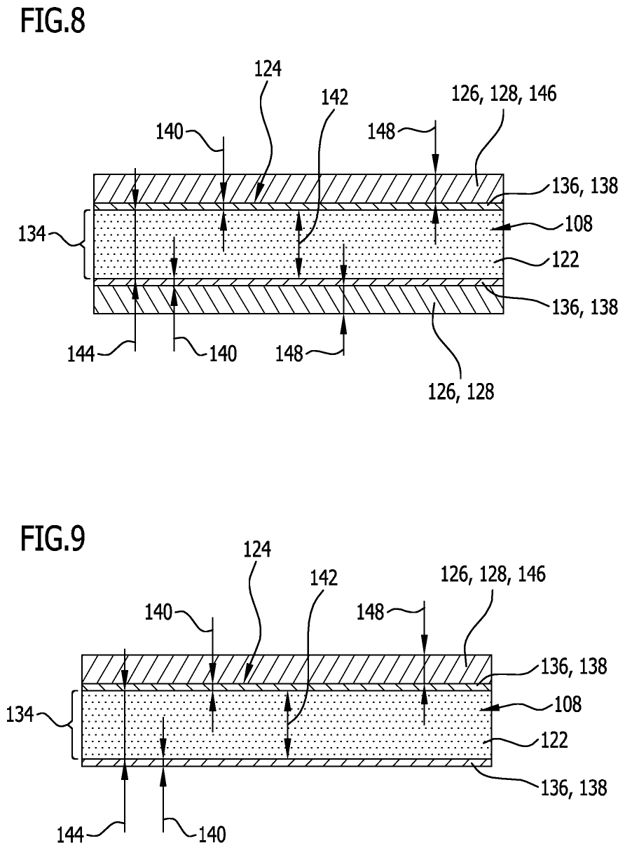

In contrast to the embodiment of a structural component 100 shown in FIGS. 1 to 4, the foamed portion 124a2 can be covered with a cover element, in particular a reinforcing element 126, on only one side of the main body 108 of the structural component 100 (see FIG. 9).

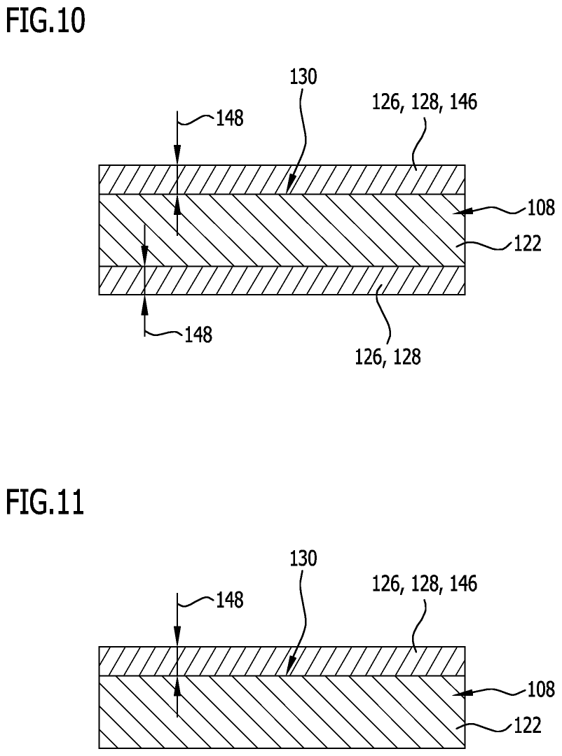

In addition, it is conceivable that the main body 108 of the structural component 100 is also partially covered in the compact portion 130, in particular in the edge portion 132, with a cover element 126 or with a reinforcing element 128, for example on two sides (see FIG. 10) or on one side (see FIG. 11).

In all other respects, the embodiment of a structural component 100 for a vehicle 102, in particular a bulkhead 104 for a passenger car 106, shown in FIG. 5, corresponds in terms of structure and function to the embodiment of a structural component 100 for a vehicle 102, in particular a bulkhead 104 for a passenger car 106, shown in FIGS. 1 to 4, such that reference can be made to their description above in this respect.

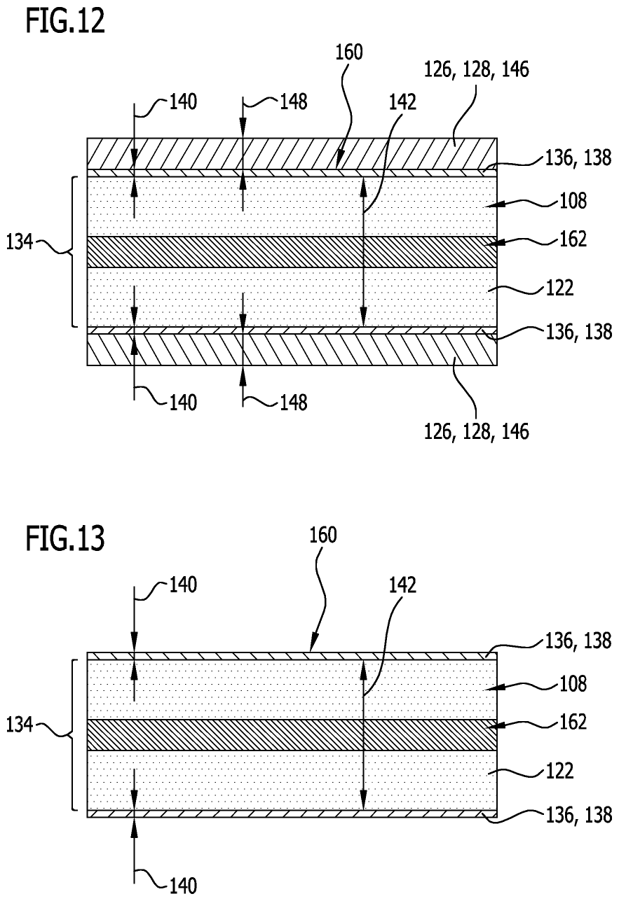

An embodiment of a structural component 100 for a vehicle 102, in particular a bulkhead 104 for a passenger car 106, shown in FIG. 12, differs from the embodiment of a structural component 100 for a vehicle 102, in particular a bulkhead 104 for a passenger car 106, shown in FIGS. 1 to 4, substantially in that the main body 108 of the structural component 100 comprises a foamed and post-compressed portion 160.

The foamed and post-compressed portion 160 preferably comprises a foamed core region 134 that is arranged between two compact cover layers 136, wherein the foamed core region 134 preferably comprises a post-compressed region 162.

The compact cover layers 136 of the foamed and post-compressed portion 160 are preferably designed substantially identically to the compact cover layers 136 of a foamed portion 124.

In particular, the compact cover layers 136 of the foamed and post-compressed portion 160 have substantially the same material properties as the compact cover layers 136 of a foamed portion 124.

In the post-compressed region 162 of the foamed core region 134 of the foamed and post-compressed portion 160, the main body 108 of the structural component 100 preferably has a density that is greater than a density of the main body 108 in the foamed core region 134 of the foamed and post-compressed portion 160 outside the post-compressed region 162.

A density of the main body 108 in the post-compressed region 162 can, for example, substantially correspond to a density of the main body 108 in a compact cover layer 136 of the foamed and post-compressed portion 160.

In all other respects, the embodiment of a structural component 100 for a vehicle 102, in particular a bulkhead 104 for a passenger car 106, shown in FIG. 12, corresponds in terms of structure and function to the embodiment of a structural component 100 for a vehicle 102, in particular a bulkhead 104 for a passenger car 106, shown in FIGS. 1 to 4, such that reference can be made to their description above in this respect.

An embodiment of a structural component 100 for a vehicle 102, in particular a bulkhead 104 for a passenger car 106, shown in FIG. 13, differs from the embodiment of a structural component 100 for a vehicle 102, in particular a bulkhead 104 for a passenger car 106, shown in FIG. 12, substantially in that the main body 108 of the structural component 100 in the foamed and post-compressed portion 160 is not covered by means of a cover element 126, in particular a reinforcing element 128.

In all other respects, the embodiment of a structural component 100 for a vehicle 102, in particular a bulkhead 104 for a passenger car 106, shown in FIG. 13, corresponds in terms of structure and function to the embodiment of a structural component 100 for a vehicle 102, in particular a bulkhead 104 for a passenger car 106, shown in FIG. 12, such that reference can be made to their description above in this respect.

As a whole, a structural component 100 can be provided for a vehicle 102, in particular a bulkhead 104 for a passenger car 106, which can be produced simply and cost-effectively and preferably simultaneously meets requirements relating to weight reduction and structural integrity.

It can be favorable if the structural component 100 is designed to be load-path-compatible, wherein the cover elements 126, in particular the reinforcing elements 128, of the structural component 100 are preferably arranged on portions with an increased load.

It can be favorable if a load-path-compatible configuration of the structural component 100 is achieved by locally different material thicknesses and/or by a locally different degree of foaming and/or a locally different foaming rate.

Preferably, the structural component 100 has a reduced material requirement and an increased lightweight construction potential, wherein production costs of the structural component 100 can preferably be minimized.

1. A structural component for a vehicle, in particular a bulkhead for a road vehicle, for example for a passenger car, wherein the structural component comprises the following:
a main body, which comprises one or more foamed portions and one or more compact portions, wherein the structural component preferably also comprises one or more cover elements which cover the main body in one or more foamed portions and/or in one or more compact portions.

2. The structural component according to claim 1, wherein the main body of the structural component comprises or is formed from an injection-moldable plastic material.

3. The structural component according to claim 2, wherein the injection-moldable plastic material is a foamable plastic material.

4. The structural component according to claim 1, wherein the main body of the structural component comprises, in a respective foamed portion, a foamed core region which is arranged on a particularly compact cover layer or between two particularly compact cover layers.

5. The structural component according to claim 1, wherein
a) two compact cover layers of a foamed portion of the main body of the structural component have a distance relative to one another in the range from approximately 2 mm to approximately 50 mm, for example from approximately 3 mm to approximately 20 mm, preferably from approximately 3 mm to approximately 8 mm; and/or
b) a foamed core region of a foamed portion of the main body of the structural component has a height in the range from approximately 2 mm to approximately 50 mm, for example from approximately 3 mm to approximately 20 mm, preferably from approximately 3 mm to approximately 8 mm.

6. The structural component according to claim 1, wherein a respective compact cover layer of a foamed portion of the main body of the structural component has a thickness of at least approximately 0.2 mm, for example of at least approximately 0.5 mm, preferably of at least approximately 1 mm.

7. The structural component according to claim 1, wherein the main body of the structural component comprises multiple foamed portions, wherein a foaming rate of the injection-moldable plastic material of the main body, in particular a foamable plastic material, is different in the foamed core regions of the multiple foamed portions.

8. The structural component according to claim 1, wherein one or more cover elements of the structural component are in each case reinforcing elements, which reinforce the main body of the structural component in one or more foamed portions and/or in one or more compact portions.

9. The structural component according to claim 1, wherein one or more cover elements, in particular one or more reinforcing elements, of the structural component are connected to the main body in a firmly bonded manner, in particular by producing the main body in an injection molding process.

10. The structural component according to claim 1, wherein the one or more cover elements, in particular one or more reinforcing elements, of the structural component comprise one or more of the following or are formed by one or more of the following:
a fiber composite material, which comprises, for example, a fiber fabric, a knitted fabric, a woven fabric, and/or a nonwoven fabric;
a fiber material, for example a fiber fabric, a knitted fabric, a woven fabric, and/or a nonwoven fabric;
a veneer material;
a foil material;
a metallic material, for example a metallic sheet, a metallic mesh, a metallic knit, and/or a metallic weave.

11. The structural component according to claim 1, wherein the structural component comprises one or more functional elements, in particular one or more sleeve elements, wherein the main body of the structural component is preferably injection-molded onto the one or more functional elements, in particular onto the one or more sleeve elements.

12. The structural component according to claim 11, wherein the injection-moldable plastic material, in particular the foamable plastic material, of the main body of the structural component is designed to be compact in a region that directly surrounds a functional element, in particular a sleeve element.

13. The structural component according to claim 1, wherein the structural component comprises one or more of the following:
a mounting portion, which is defined for fixing one or more pedals, for example a brake pedal, of a vehicle, in particular a road vehicle, for example a passenger car;
a passage portion through which a steering column of a vehicle, in particular a road vehicle, for example a passenger car, can be passed.

14. The structural component according to claim 1, wherein the structural component comprises a sealing element, which is injection-molded onto the main body of the structural component.

15. The structural component according to claim 1, wherein the main body of the structural component comprises one or more stiffening elements, for example stiffening ribs, wherein injection-moldable and/or foamable plastic material of the main body of the structural component is preferably compact and/or not foamed in the one or more stiffening elements, in particular the stiffening ribs, of the main body of the structural component.

16. The structural component according to claim 1, wherein the main body of the structural component comprises a foamed and post-compressed portion, wherein the foamed and post-compressed portion preferably comprises a foamed core region, which is arranged between two cover layers, in particular compact cover layers, wherein the foamed core region preferably comprises a post-compressed region.

17. The structural component according to claim 1, wherein the structural component comprises the following:
a first foamed portion;
a second foamed portion;
a compact portion; and
two reinforcing elements,
wherein the two reinforcing elements cover, in particular completely, a surface of the main body of the structural component in the first foamed portion,
wherein the main body of the structural component in the first foamed portion has a density that is smaller than a density of the main body in the second foamed portion, and
wherein the compact portion forms a circumferential edge portion of the main body of the structural component, which surrounds the first foamed portion and the second foamed portion.

18. A vehicle, in particular a road vehicle, for example a passenger car, wherein the vehicle comprises a structural component according to claim 1.

19. A method for producing a structural component, in particular a structural component according to claim 1, wherein the method comprises the following steps:
Providing a cover element, in particular a reinforcing element;
Inserting one or more cover elements, in particular one or more reinforcing elements, into a cavity of a shaping tool;
Injecting a foamable plastic material into the cavity of the shaping tool;
Foaming the foamable plastic material.

20. The method according to claim 19, wherein a waiting or holding time is observed prior to the foaming of the foamable plastic material.

21. The method according to claim 19, wherein individual slide elements of a shaping tool for foaming the foamable plastic material are moved over stroke distances that are different from one another.

22. The method according to claim 19, wherein the foamable plastic material is post-compressed at least in portions after the foaming of the same.
